(19) United States
(12) Patent Application Publication
(10) Pub. No.: US 2012/0125477 A1
(43) Pub. Date: May 24, 2012

(54) Coiled Valve and Methods of Making and Using the Same

(75) Inventors: Joseph E. Owensby, Spartanburg, SC (US); Loran T. Bradey, Moore, SC (US); Howard Dean Conner, Mauldin, SC (US); Janet W. Rivett, Simpsonville, SC (US)

(73) Assignee: CRYOVAC, INC., Duncan, SC (US)

(21) Appl. No.: 12/950,182

(22) Filed: Nov. 19, 2010

(51) Int. Cl. B65B 1/04; B67D 7/00; B65D 30/24

(52) U.S. Cl. 141/1; 251/366; 383/44; 137/14; 222/1

(57) ABSTRACT

The presently disclosed subject matter is generally directed to a reclosable one-way valve. Particularly, the valve comprises two sheets of thermoplastic material sealed together in a face-to-face relationship to define a channel there between. At least one of the two sheets comprises a natural curl tendency such that the valve is movable between an open, uncoiled position and a closed, coiled position.

### FIELD OF THE INVENTION

The presently disclosed subject matter is directed to a flexible valve that includes two film plies joined together to define an internal channel. At least one of the film plies contains a curling tendency, resulting in a coiled valve configuration. The valve is moveable between an uncoiled position to allow flow through the internal channel and a coiled position to substantially prevent flow through the channel.

### BACKGROUND

Various versions of valves for controlling packaged products are known in the art. However, such prior art valve assemblies are notorious for failing to open or close. In addition, prior art valves are typically intricate mechanisms and therefore add to the cost and complexity of the packaging. Further, such prior art valves, due to their complexity, generally require an amount of space that is incompatible or costly to locate on the product packaging material. Continuing, prior art valves are typically best suited for one purpose, such as venting applications or dispensing applications.

Thus, there is a need in the art for a valve that contains a relatively simple design, is economical in manufacture and assembly, and has a useful and reliable in-service life. In addition, there is also a need for a valve that can be used for a plurality of applications, such as venting, dispensing, filling, and the like.

### SUMMARY

In some embodiments, the presently disclosed subject matter is directed to a flexible valve comprising a first sheet of thermoplastic material and a second sheet of thermoplastic material in juxtaposed face-to-face relationship with each other. The first and second sheets are sealed together along the longitudinal edges of the sheets, defining a channel there between and defining an inlet end and an outlet end. In addition, at least one of the first and second sheets comprises a curl tendency in one direction. The valve is movable between: (a) an open, uncoiled position to allow fluid flow through the valve and (b) a closed, coiled position to substantially prevent fluid flow through the valve. The valve is capable of maintaining itself in a closed position at rest and an open position when in use without the need for external manipulation of the valve.

In some embodiments, the presently disclosed subject matter is directed to a package comprising a flexible valve comprising a first sheet of thermoplastic material and a second sheet of thermoplastic material in juxtaposed face-to-face relationship with each other. The first and second sheets are sealed together along the longitudinal edges of the sheets, defining a channel there between and defining an inlet end and an outlet end. In addition, at least one of the first and second sheets comprises a curl tendency in one direction. The valve is movable between: (a) an open, uncoiled position to allow fluid flow through the valve and (b) a closed, coiled position to substantially prevent fluid flow through the valve. The valve is capable of maintaining itself in a closed position at rest and an open position when in use without the need for external manipulation of the valve.

In some embodiments, the presently disclosed subject matter is directed to a method of venting a package. The method comprises providing a package comprising a product housed within the interior of the package. The package also comprises a flexible valve comprising a first sheet of thermoplastic material and a second sheet of thermoplastic material in juxtaposed face-to-face relationship with each other. The first and second sheets are sealed together along the longitudinal edges of the sheets, defining a channel there between and defining an inlet end and an outlet end. In addition, at least one of the first and second sheets comprises a curl tendency in one direction. The valve is movable between: (a) an open, uncoiled position to allow fluid flow through the valve and (b) a closed, coiled position to substantially prevent fluid flow through the valve. The valve is capable of maintaining itself in a closed position at rest and an open position when in use without the need for external manipulation of the valve. The method further comprises increasing the pressure within the interior of the package to cause the valve to open and uncoil to vent the package.

In some embodiments, the presently disclosed subject matter is directed to a method of dispensing a product from the interior of the package. Particularly, the method comprises providing a package comprising a product housed within the interior of the package. The package also comprises a flexible valve comprising: a first sheet of thermoplastic material and a second sheet of thermoplastic material in juxtaposed face-to-face relationship with each other, wherein said first and second sheets are sealed together along the longitudinal edges of said sheets, defining a channel there between and defining an inlet end and an outlet end; and wherein at least one of said first and second sheets comprises a curl tendency. The method further comprises increasing the pressure within the interior of the package to allow the valve to open and uncoil to dispense the product. The valve is movable between an open, uncoiled position to allow product flow through the valve and a closed, coiled position to substantially prevent product flow through the valve. The valve is capable of maintaining itself in a closed position at rest and an open position when in use without the need for external manipulation of the valve.

In some embodiments, the presently disclosed subject matter is directed to a method of inflating an inflatable package. Particularly, the disclosed method comprises providing an inflatable package comprising a flexible valve comprising a first sheet of thermoplastic material and a second sheet of thermoplastic material in juxtaposed face-to-face relationship with each other, wherein said first and second sheets are sealed together along the longitudinal edges of said sheets, defining a channel there between and defining an inlet end and an outlet end; and wherein at least one of said first and second sheets comprises a curl tendency. The method further comprises uncoiling the valve, inserting an inflation device into the channel of the valve, inserting air into the interior of the package via the inflation device until it reaches a desired level, withdrawing the inflation device from the valve channel, and allowing the valve to recurl. The valve is movable between an open, uncoiled position to allow air flow through the valve and a closed, coiled position to substantially prevent air flow through the valve. The valve is capable of maintaining itself in a closed position at rest without the need for external manipulation of the valve.

In some embodiments, the presently disclosed subject matter is directed to a method of venting a package. Particularly, the method comprises providing a package comprising a product housed within the interior of the package. The package also comprises a flexible valve comprising: a first sheet of thermoplastic material and a second sheet of thermoplastic material in juxtaposed face-to-face relationship with each other, wherein said first and second sheets are sealed together along the longitudinal edges of said sheets, defining a channel there between and defining an inlet end and an outlet end; and wherein at least one of said first and second sheets comprises a curl tendency. The method further comprises creating a differential pressure across the inner and outer portions of the package to cause the valve to open and uncoil to vent the package. The valve is movable between an open, uncoiled position to allow air flow through the valve and a closed, coiled position to substantially prevent air flow through the valve. The valve is capable of maintaining itself in a closed position at rest and an open position when in use without the need for external manipulation of the valve.

### BRIEF DESCRIPTION OF THE DRAWINGS

FIG. 1a is a perspective view of one embodiment of the disclosed valve in an uncoiled position.

FIG. 1b is a perspective view of the valve of FIG. 1a during coiling.

FIG. 1c is a perspective view of the valve of FIG. 1a in a coiled position.

FIG. 2a is a front elevation view of one embodiment of a package comprising the disclosed valve in a coiled position.

FIG. 2b is a front elevation view of one embodiment of the valve of FIG. 2a in an uncoiled position.

FIG. 2c is an enlarged fragmentary view of the exhaust opening of the uncoiled valve of FIG. 2b.

FIG. 3a is a front elevation view of one embodiment of a package comprising the disclosed valve in a coiled position.

FIG. 3b is a fragmentary sectional view taken along line 3b-3b in FIG. 3a.

FIG. 3c is an enlarged fragmentary view of the valve of FIG. 3a.

FIG. 3d is an enlarged fragmentary view of an opening in a bag.

FIG. 3e illustrates the bag opening of FIG. 3d configured with one embodiment of the disclosed valve.

FIG. 4a is a front elevation view of one embodiment of a package comprising the disclosed valve in a coiled position.

FIG. 4b is a front elevation view of the valve of FIG. 4a during uncoiling.

FIG. 4c is a front elevation view of the package of FIG. 4a comprising the disclosed valve in an uncoiled position.

FIG. 4d is an enlarged fragmentary view of the valve of FIG. 4c.

FIG. 5a is a perspective view of a package comprising one embodiment of the disclosed valve in a coiled position.

FIG. 5b is a perspective view of the package of FIG. 5a during uncoiling of the valve.

FIG. 5c is a perspective view of the package of FIG. 5a comprising the valve in an uncoiled position.

FIG. 6a is a front elevation view of a package comprising one embodiment of the disclosed valve in a coiled position.

FIG. 6b is a front elevation view of the package of FIG. 6a during uncoiling of the valve.

FIG. 6c is a front elevation view of the package of FIG. 6a comprising the valve in an uncoiled position.

FIG. 7a is a perspective view of a package comprising one embodiment of the disclosed valve in an uncoiled position.

FIG. 7b is a perspective view of the package of FIG. 7a comprising the valve in a coiled position.

### DETAILED DESCRIPTION

### I. General Considerations

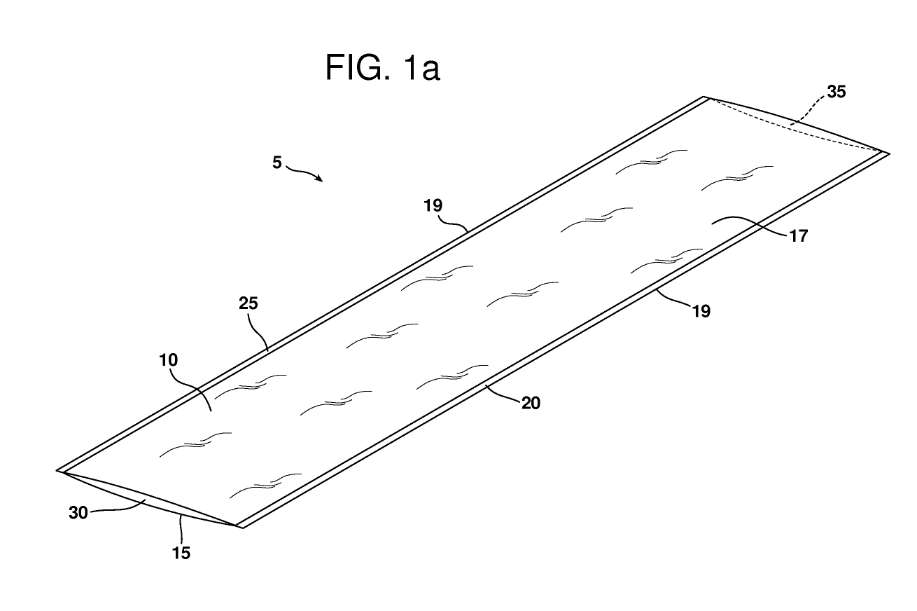

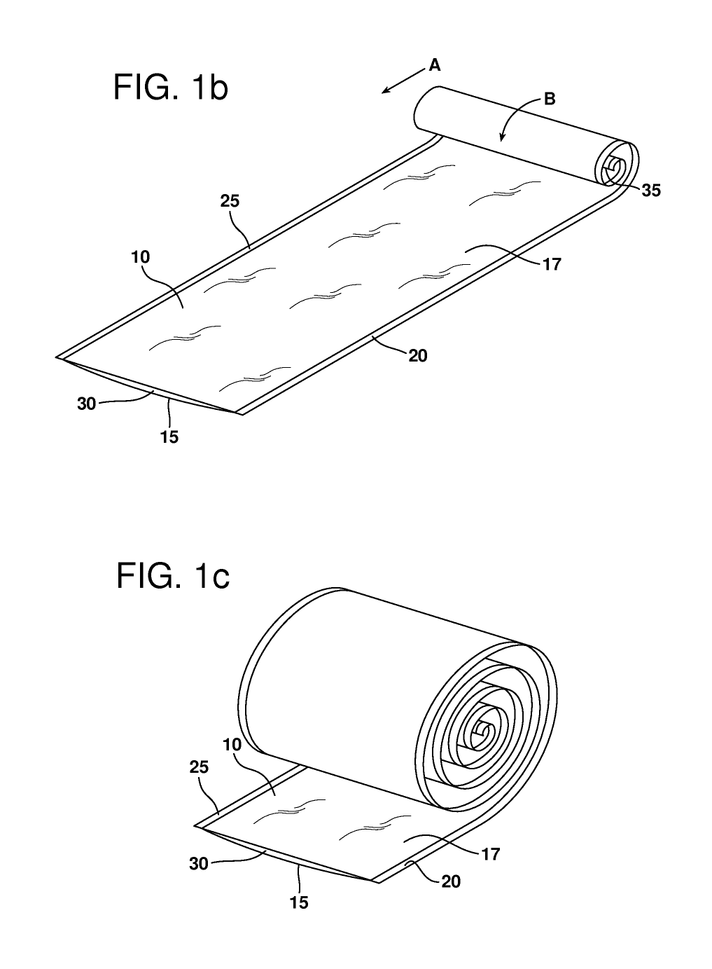

The presently disclosed subject matter is generally directed to a reclosable one-way valve. Particularly, as illustrated in FIG. 1a, valve 5 is constructed from upper and lower films 10, 15 that are parallel and coplanar with each other. Upper and lower films 10, 15 are secured together at seals 20, 25 along the longitudinal sides of the films to define channel 17. Input opening 30 of valve 5 can be secured within a structure (such as a food package), as set forth in more detail herein below. Exhaust opening 35 can be configured as an “open” end such that steam or air (in venting applications) and/or the product housed within the package (in dispensing applications) can exit the package.

As indicated in FIG. 1b, after the venting or dispensing application, valve 5 initiates a self-coiling mechanism to close and seal exhaust opening 35 as a result of a natural curl tendency in films 10 and/or 15. Particularly, arrow A illustrates the rolling direction of exhaust opening 35 of valve 5 towards input opening 30, while arrow B illustrates the bending direction. Thus, the valve is spirally wound a plurality of times about an axis to form the coiled structure of FIG. 1c. In so doing, sheets 10 and 15 are pressed against one another, thereby closing exhaust opening 35 and creating a relatively air tight seal.

Accordingly, valve 5 is maintained in the rolled position of FIG. 1c during normal (at rest) conditions. However, the valve opens during venting and/or dispensing applications through unrolling (as illustrated in FIG. 1a), thereby exposing exhaust opening 35 to allow venting or dispensing to occur. After the venting and/or dispensing application has ceased, valve 5 re-rolls (FIG. 1b) to again maintain the rolled position of FIG. 1c.

### II. Definitions

While the following terms are believed to be understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” can refer to “one or more” when used in the subject specification, including the claims. Thus, for example, reference to “a film” can include a plurality of such films, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments ±20%, in some embodiments ±10%, in some embodiments ±5%, in some embodiments ±1%, in some embodiments ±0.5%, and in some embodiments to ±0.1%, from the specified amount, as such variations are appropriate in the disclosed materials and methods.

As used herein, the term “abuse layer” can refer to an outer film layer and/or an inner film layer, so long as the film layer serves to resist abrasion, puncture, and other potential causes of reduction of package integrity, as well as potential causes of reduction of package appearance quality. Abuse layers can comprise any polymer, so long as the polymer contributes to achieving an integrity goal and/or an appearance goal. In some embodiments, the abuse layer can comprise polyamide, ethylene/propylene copolymer, and/or combinations thereof.

As used herein, the terms “barrier” and/or “barrier layer” can refer to the ability of a film or film layer to serve as a barrier to one or more gases. For example, oxygen barrier layers can comprise, but are not limited to, ethylene/vinyl alcohol copolymer, polyvinyl chloride, polyvinylidene chloride, polyamide, polyester, polyacrylonitrile, and the like, as known to those of ordinary skill in the art.

As used herein, the term “bulk layer” can refer to any layer of a film that is present for the purpose of increasing the abuse-resistance, toughness, and/or modulus of a film. In some embodiments, bulk layers can comprise polyolefin, ethylene/alpha-olefin copolymer, ethylene/alpha-olefin copolymer plastomer, low density polyethylene, linear low density polyethylene, and combinations thereof.

The term “channel” as used herein refers to an internal valve passageway through which a fluid can flow. In some embodiments, the channel can be formed from the unsealed space between the longitudinal seals of two sheets used to construct the valve.

As used herein, the term “coil” refers to a connected series of spirals or loops.

As used herein, the term “copolymer” can refer to polymers formed by the polymerization reaction of at least two different monomers. For example, the term “copolymer” can include the copolymerization reaction product of ethylene and an alpha-olefin, such as 1-hexene. However, in some embodiments the term “copolymer” can include, for example, the copolymerization of a mixture of ethylene, propylene, 1-hexene, and 1-octene.

As used herein, the terms “core” and “core layer” can refer to any internal film layer that has a primary function other than serving as an adhesive or compatibilizer for adhering two layers to one another. In some embodiments, the core layer or layers provide a multilayer film with a desired quality, such as level of strength, modulus, optics, added abuse resistance, and/or specific impermeability.

The term “curl tendency” as used herein refers to the inclination of at least one of the films that form the disclosed valve to form a coiled structure. Such curl tendency can result from slightly stretching the film, exposure of the film to an external stimulus (such as heat, humidity, water), heat setting the film, as well as other methods known to those of ordinary skill in the packaging art.

As used herein, the term “film” can include, but is not limited to, a laminate, sheet, web, coating, and/or the like, that can be used to package a product. The film can be a rigid, semi-rigid, or flexible product. In some embodiments, the disclosed film is produced as a fully coextruded film, i.e., all layers of the film emerging from a single die at the same time. In some embodiments, the film is made using a flat cast film production process or a round cast film production process. Alternatively, the film can be made using a blown film process, double bubble process, triple bubble process, and/or adhesive or extrusion coating lamination in some embodiments. Such methods are well known to those of ordinary skill in the art.

As used herein, the term “flexible” refers to materials and valves comprising such materials that are pliant and capable of undergoing a large variety of changes in shape, e.g., bending, creasing, folding, rolling, crumpling, etc., with substantially no damage thereto in response to the action of an applied force. In some embodiments, flexible materials are capable of substantially returning to their general original shape when the applied force is removed.

The term “fluid” as used herein refers to any material that can be expelled through a valve. Such substances can include liquids, gelatinous substances, gases, solids, and combinations thereof. In addition, for purposes of the present disclosure, it should be understood that the term “fluid” can be used interchangeably with the terms “liquid,” “air,” “gas,” and the like herein below.

As used herein, the term “food product” refers to any nourishing substance that is eaten or otherwise taken into the body to sustain life, provide energy, promote growth, and/or the like. For example, in some embodiments, food products can include, but are not limited to, meats, vegetables, fruits, starches, and combinations thereof. In some embodiments, food products can include individual food components or mixtures thereof. It should be noted that the presently disclosed subject matter is not limited to use with food products. Rather, the disclosed valve can be used with a wide variety of food and non-food products, as would be apparent to those of ordinary skill in the art.

As used herein, the term “heat seal” refers to any seal of a first region of a film surface to a second region of a film surface, wherein the seal is formed by heating the regions to at least their respective seal initiation temperatures. Heat-sealing is the process of joining two or more thermoplastic films or sheets by heating areas in contact with each other to the temperature at which fusion occurs, usually aided by pressure. In some embodiments, heat-sealing can be inclusive of thermal sealing, melt-bead sealing, impulse sealing, dielectric sealing, and/or ultrasonic sealing. The heating can be performed by any one or more of a wide variety of means, such as (but not limited to) a heated bar, hot wire, hot air, infrared radiation, ultrasonic sealing, and the like.

The term “inlet” refers to the fluid entrance portion of a valve.

The term “lamination” refers to the bonding of two or more film layers to each other, e.g., by the use of an adhesive.

The term “machine direction” as used herein refers to the direction along the length of a film (i.e., in the direction of the film as it is formed during extrusion and/or coating).

As used herein, the term “multilayer film” can refer to a thermoplastic film having one or more layers formed from polymeric or other materials that are bonded together by any conventional or suitable method, including one or more of the following methods: coextrusion, extrusion coating, lamination, vapor deposition coating, solvent coating, emulsion coating, or suspension coating.

The term “oriented” as used herein refers to a polymer-containing material that has been stretched at the softening temperature but below the melting temperature, followed by being “set” in the stretched configuration by cooling the material while substantially retaining the stretched dimensions. Upon subsequently heating unrestrained, unannealed, oriented polymer-containing material to its orientation temperature, heat shrinkage is produced almost to the original unstretched, i.e., pre-oriented dimensions.

The term “outlet” as used herein refers to the fluid exit portion of a valve.

As used herein, the term “oxygen-impermeable,” or “barrier” and the phrase “oxygen-impermeable layer” or “barrier layer,” as applied to films and/or layers, is used with reference to the ability of a film or layer to serve as a barrier to one or more gases (i.e., gaseous O₂). Such barrier materials can include (but are not limited to) ethylene/vinyl alcohol copolymer, polyvinyl alcohol homopolymer, polyvinyl chloride, homopolymer and copolymer of polyvinylidene chloride, polyalkylene carbonate, polyamide, polyethylene naphthalate, polyester, polyacrylonitrile, homopolymer and copolymer, liquid crystal polymer, SiOx, carbon, metal, metal oxide, and the like, as known to those of ordinary skill in the art. In some embodiments, the oxygen-impermeable film or layer has an oxygen transmission rate of no more than 100 cc O₂/m²·day·atm; in some embodiments, less than 50 cc O₂/m²·day·atm; in some embodiments, less than 25 cc O₂/m²·day·atm; in some embodiments, less than 10 cc O₂/m²·day·atm; in some embodiments, less than 5 cc O₂/m²·day·atm; and in some embodiments, less than 1 cc O₂/m²·day·atm (tested at 1 mil thick and at 25° C. in accordance with ASTM D3985, herein incorporated by reference in its entirety).

As used herein, the term “oxygen-permeable” as applied to films and/or film layers refers to a film packaging material that can permit the transfer of oxygen from the exterior of the film (i.e., the side of the film not in contact with the packaged product) to the interior of the film (i.e., the side of the film in contact with the packaged product). In some embodiments, “oxygen-permeable” can refer to films or layers that have a gas (e.g., oxygen) transmission rate of at least about 1,000 cc/m²/24 hrs/atm at 73° F.; in some embodiments, at least about 5,000 cc/m²/24 hrs/atm at 73° F.; in some embodiments, at least about 10,000 cc/m²/24 hrs/atm at 73° F.; in some embodiments, at least about 50,000 cc/m²/24 hrs/atm at 73° F.; and in some embodiments, at least about 100,000 cc/m²/24 hrs/atm at 73° F. The term “permeable” can also refer to films that do not have high gas permeability, but that are sufficiently permeable to affect a sufficiently rapid bloom for the particular product and particular end-use application.

As used herein, the term “package” refers to packaging materials configured around a product being packaged, and can include (but are not limited to) bags, pouches, trays, and the like. In some embodiments, the phrase “packaged product,” as used herein, refers to the combination of a product that is surrounded by a packaging material.

As used herein, the term “polymer” can refer to the product of a polymerization reaction, and can be inclusive of homopolymers, copolymers, terpolymers, and the like. In some embodiments, the layers of a film can consist essentially of a single polymer, or can have still additional polymers together therewith, i.e., blended therewith. The term “polymeric” can be used to describe a polymer-containing material (i.e., a polymeric film).

As used herein, the term “seal” can refer to any seal of a first region of a film surface to a second region of a film or substrate surface. In some embodiments, the seal can be formed by heating the regions to at least their respective seal initiation temperatures using a heated bar, hot air, infrared radiation, ultrasonic sealing, and the like. In some embodiments, the seal can be formed by an adhesive. Such adhesives are well known in the packaging art. Alternatively or in addition, in some embodiments, the seal can be formed using a UV or e-beam curable adhesive seal.

As used herein, the terms “seal layer”, “sealing layer”, “heat seal layer”, and/or “sealant layer” refer to an outer film layer or layers involved in heat sealing of the film to itself, another film layer of the same or another film, and/or another article that is not a film. Heat sealing can be performed by any one or more of a wide variety of manners known to those of ordinary skill in art, including using heat seal technique (e.g., melt-bead sealing, thermal sealing, impulse sealing, ultrasonic sealing, hot air, hot wire, infrared radiation, and the like), adhesive sealing, UV-curable adhesive sealing, and the like.

The term “sheet” as used herein refers to materials that include webs, strips, films, and the like.

As used herein, the term “thermoplastic” refers to uncrosslinked polymers of a thermally sensitive material that flow under the application of heat or pressure.

As used herein, the term “tie layer” can refer to any internal film layer having the primary purpose of adhering two layers to one another. In some embodiments, the tie layers can comprise any nonpolar polymer having a polar group grafted thereon, such that the polymer is capable of covalent bonding to polar polymers such as polyamide and ethylene/vinyl alcohol copolymer. In some embodiments, the tie layers can comprise, but are not limited to, modified polyolefin, modified ethylene/vinyl acetate copolymer, and/or homogeneous ethylene/alpha-olefin copolymer.

The term “transverse direction” as used herein refers to the direction across a film (i.e., the direction that is perpendicular to the machine direction).

The term “valve” as used herein refers to any through which the flow of fluid can be started, stopped, or regulated. In some embodiments, a valve in accordance with the presently disclosed subject matter includes two sheets of thermoplastic material in juxtaposed face-to-face relationship with each other and secured along their longitudinal edges to define a passageway. At least one of the two sheet contains a curl tendency such that the valve maintains itself in a closed, coiled position at rest and in an uncoiled, open position when in use.

All compositional percentages used herein are presented on a “by weight” basis, unless designated otherwise.

### III. The Disclosed Valve

III.A. Generally

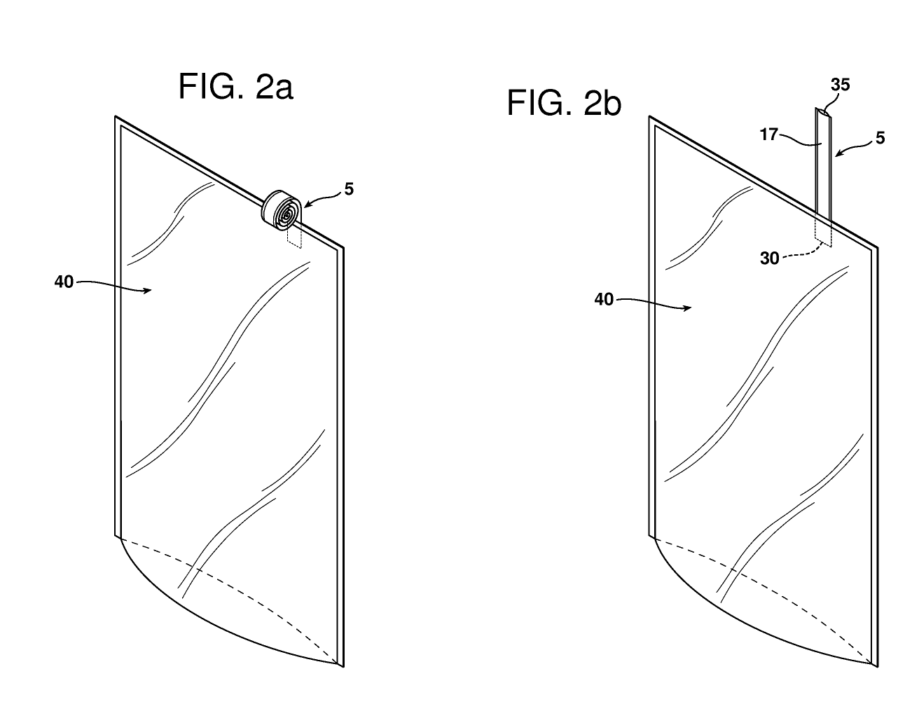

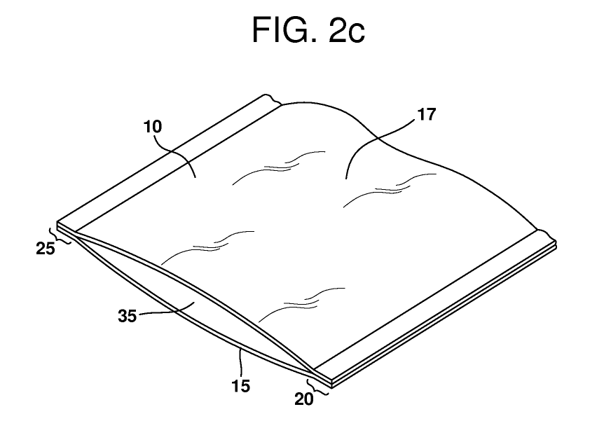

As set forth above, the presently disclosed subject matter is generally directed to a reclosable one-way valve. The disclosed valve is incorporated into a package in fluid-tight fashion, as illustrated in FIGS. 2a and 2b. In some embodiments, valve 5 is a pressure-activated valve that automatically vents when the pressure within package 40 reaches a specified triggering pressure. For example, in some embodiments, valve 5 can be triggered when cooking a food product within package 40, when manually expressing the air from a compression-type package, and the like.

To elaborate, when the pressure within the interior of package 40 is approximately atmospheric pressure, valve 5 assumes its coiled position as depicted in FIG. 2a (i.e., in a rolled configuration as a result of the curl tendency in films 10 and/or 15). In the coiled position, films 10, 15 of valve 5 are in contact with each other and channel 17 is closed. As the pressure within package 40 increases (such as during cooking of a food product housed within the package, for example), air is forced into valve 5. Air flow, introduced from valve internal opening 30 toward exhaust opening 35 separates films 10 and 15 and opens channel 17 such that air flow enters. Thus, as the pressure within package 40 increases, the movement of air into channel 17 overcomes the natural curling tendency of films 10 and/or 15. As a result, valve 5 uncoils and assumes an extended position, as illustrated in FIG. 2b. In the extended position, air from within package 5 can escape the interior of the package through channel 17 and exhaust opening 35, thus venting the package. FIG. 2c depicts the movement of sheets 10, 15 at exhaust opening 35 during package venting. Specifically, upper and lower films 10, 15 separate to allow the package to vent.

When the pressure within package 5 is reduced (such as after cooking, for example), films 10, 15 converge towards one another, thereby closing and sealing exhaust opening 35. In addition, because the pressure within the package is not enough to overcome the curling tendency of films 10 and/or 15, valve 5 will return to its original rolled position (FIG. 2a).

III.B. Curl Tendency

As set forth herein above, to achieve the coiled valve structure illustrated in FIG. 1c, at least one of films 10, 15 comprises a curl tendency. As would be apparent to those of ordinary skill in the art, if both films 10, 15 contain a curl tendency, they must be positioned such that the curl direction of each film complements the curl direction of the other film (i.e., unidirectional curl). As films 10, 15 are coiled, additional stiffness is provided to the films. Particularly, the coiling creates additional force to spread apart the edges of films 10, 15 which helps bring the opposing layers of film together to provide a better seal in the coiled position. Accordingly, the disclosed valve exhibits effective reclosure characteristics, especially compared to similar valves containing only flat (non-coiled) films.

The curl tendency in films 10, 15 can be constructed using any of a wide variety of methods well known in the art. For example, in some embodiments, at least one layer of films 10 and/or 15 can be slightly stretched at the time of lamination, while at least one additional layer on the film is not stretched. As a result, the film structure is curled in one direction. For example, in some embodiments at least one of films 10, 15 can be stretched using slow and fast draw rollers.

Alternatively, in some embodiments, films 10 and/or 15 comprise at least one heat shrinkable layer such that when the film is exposed to a heat source, the shrinkable layer reduces in size and the film curls. Heat shrinkable layers are well known in the art. For example, in some embodiments, suitable heat shrinkable layers can include (but are not limited to) ethylene homopolymers, ethylene alpha-olefin copolymer, propylene homopolymers, propylene copolymers with ethylene or an alpha-olefin, amorphous poly-alpha-olefin, styrene butadiene, cyclic olefin copolymers, ethylene ethyl acrylate (“EEA”), ethylene butyl acrylate (“EBA”), ionomer, polyvinyl chlorides, polyamide, polycarbonate, polyester (including copolyesters), polyvinyl acetate (“PVA”), polystyrene, polyacrylate, nylon, poly(methyl methacrylate) (“PMMA), polyacrylonitrile (“PAN”), polyethylene naphthalate (“PEN”), and combinations thereof. To induce shrink of the shrinkable layer, the film can be exposed to temperature of 90° C. to 180° C. for a time period of about 0.5 seconds to about 12 hours. After exposure to heat, the heat shrinkable layer can exhibit at least 10% shrink in at least one direction, resulting in a curled film. See, for example, U.S. Pat. Nos. 7,687,123; 7,517,569; and 6,610,392, the entire disclosures of which are hereby incorporated by reference herein.

In some embodiments, films 10 and/or 15 can be a laminated film comprising a layer that has been substantially heat set biaxially or monoaxially oriented. For example, suitable heat set oriented films can include (but are not limited to) B503 (available from AET Films, New Castle Del., United States of America), Mylar® 822 (available from DuPon Teijin Films (Wilmington, Del., United States of America), and Capran® Emblem™ 1530 (available from Honeywell International, Inc., Morristown, N.J., United States of America). Such films can be monolayer or multilayer and can have heat sealable layers applied to one or both surfaces. Machine direction and/or transverse direction heat set oriented films can be used either in a laminated film or as stand alone films.

In some embodiments, the curl tendency in films 10 and/or 15 can be achieved by coextruding a film that has at least one layer that either shrinks or expands when exposed to an outside stimulus, such as (but not limited to) water, humidity, heat, and the like. For example, in some embodiments, film 10 and/or 15 can comprise a nylon/PET layer. As is known in the art, the nylon component tends to crystallize over time or when exposed to water, thereby resulting in a curling of the film.

In some embodiments, the curl tendency in films 10 and/or 15 can be achieved by co-extruding films comprising an asymmetric composition wherein each layer of the film comprises different a compositions such that each layer crystallizes and shrinks at a different rate. As a result, the film curls upon quenching. These films can be extruded on blown, cast, double bubble, and/or triple bubble processes.

Further, the curl tendency in films 10 and/or 15 can be constructed by producing a flattened tube from appropriate high temperature materials and heat setting the tube in the desired curl position. As used herein, “heat setting” refers to the process of allowing the polymer chains of a film to equilibrate or rearrange to the induced oriented structure, resulting from the deformation at an elevated temperature. During this time period, the polymer in the deformed state can be maintained at an elevated temperature to allow polymer chains to adopt the oriented structure. In some embodiments, the polymer can be maintained in the deformed state by maintaining a radial pressure. The polymer tube can then be cooled to a certain temperature either before or after decreasing the pressure. Cooling the tube helps ensure that the tube maintains the proper shape, size, and length following its formation. Upon cooling, the deformed tube retains the length and shape imposed by an inner surface of a mold used. Thus, during such heat setting processes, the film is set and then heated to maintain a desired film shape, as would be known to those of ordinary skill in the art. In some embodiments, the temperature range can be less than the melting point of the resin for a period of about 0.1 seconds to 1 hour.

III.C. Methods of Making Valve 5

Valve 5 can be constructed using any of a wide variety of methods well known to those of ordinary skill in the packaging art. For example, as illustrated in FIG. 1a, the valve can be constructed from upper film 10 and lower film 15 positioned in a face-to-face relationship. Films 10 and 15 can be bonded together along edges 19 to form gas-impermeable edge seals 20, 25, thereby defining valve inlet 30, valve outlet 35, and channel 17 between the inlet and outlet. Seals 20, 25 can be any conventional and/or appropriate type of seal, including (but not limited to) heat-seals, adhesive bonds, cohesive bonds, and the like, including combinations of the foregoing.

Upper and lower films 10, 15 can include any of a wide variety of commercially available materials known in the art. For example, in some embodiments, films 10, 15 can comprise any flexible material that can enclose a fluid or gas as herein described, including various thermoplastic materials, e.g., polyethylene homopolymer or copolymer, polypropylene homopolymer or copolymer, and the like. Non-limiting examples of suitable thermoplastic polymers include polyethylene homopolymers, such as low density polyethylene (LDPE), high density polyethylene (HDPE), and polyethylene copolymers such as, e.g., ionomers, ethylene vinyl acetate (“EVA”), ethylene methyl acrylate (“EMA”), ethylene butyl acrylate (“EBA”), styrene butadiene, ethylene ethyl acrylate (“EEA”), cyclic olefins, heterogeneous (Zeigler-Natta catalyzed) ethylene/alpha-olefin copolymers, and homogeneous (metallocene, single-cite catalyzed) ethylene/alpha-olefin copolymers. Ethylene/alpha-olefin copolymers are copolymers of ethylene with one or more comonomers selected from C₃ to C₂₀ alpha-olefins, such as 1-butene, 1-pentene, 1-hexene, 1-octene, methyl pentene and the like, in which the polymer molecules comprise long chains with relatively few side chain branches, including linear low density polyethylene (LLDPE), linear medium density polyethylene (LMDPE), very low density polyethylene (VLDPE), and ultra-low density polyethylene (ULDPE). Various other materials are also suitable such as, e.g., polypropylene homopolymer or polypropylene copolymer (e.g., propylene/ethylene copolymer), polyesters, polystyrenes, polyamides, polycarbonates, PMMA, PAN, PEN, and the like.

Films 10, 15 can be constructed using any of a wide variety of methods known in the packaging art. For example, in some embodiments the films can be constructed using any coextrusion process known in the art, such as by melting the component polymer(s) and extruding or coextruding them through one or more flat or annular dies.

Generally, films 10, 15 can be multilayer or monolayer. Typically, however, the films employed will have two or more layers to incorporate a variety of properties, such as, for example, sealability, gas impermeability, and toughness into a single film. Thus, in some embodiments, films 10, 15 can comprise a total of from about 1 to about 20 layers; in some embodiments, from about 4 to about 12 layers; and in some embodiments, from about 5 to about 9 layers. Accordingly, the disclosed film can comprise 1, 2, 3, 4, 5, 6, 7, 8, 9, 10, 11, 12, 13, 14, 15, 16, 17, 18, 19, or 20 layers. One of ordinary skill in the art would also recognize that films 10, 15 can comprise more than 20 layers, such as in embodiments wherein the films comprise microlayering technology.

Thus, films 10, 15 can be provided in sheet or film form and can be any of the films commonly used for the disclosed type of packaging. Accordingly, films 10, 15 can comprise one or more barrier layers, seal layers, tie layers, abuse layers, and/or bulk layers.

### IV. Methods of Using Valve 5

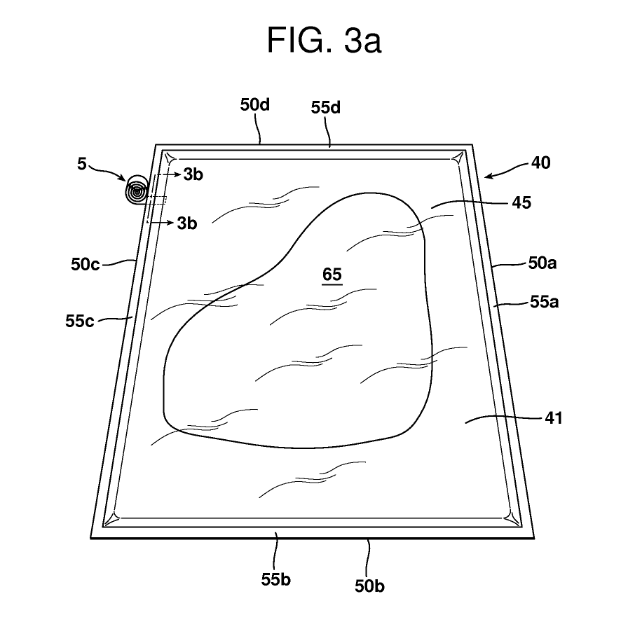

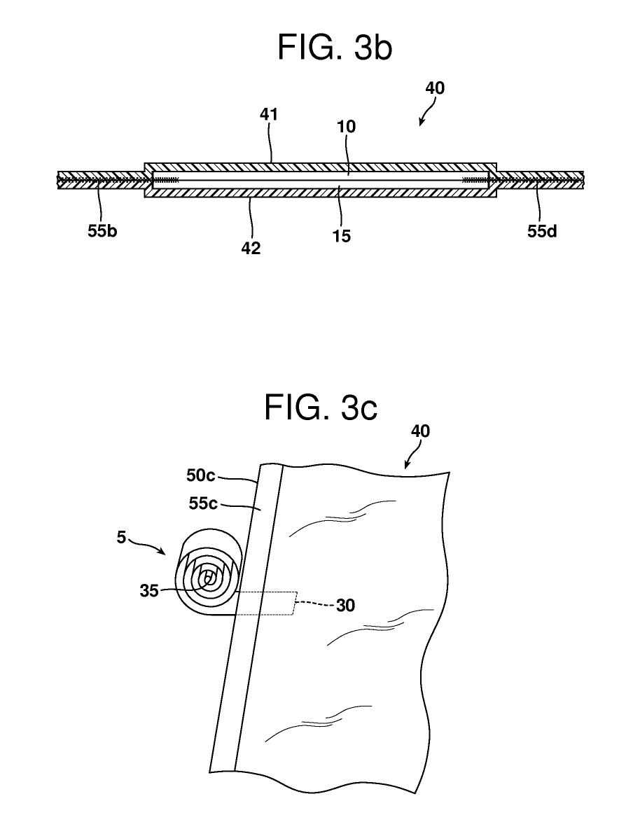

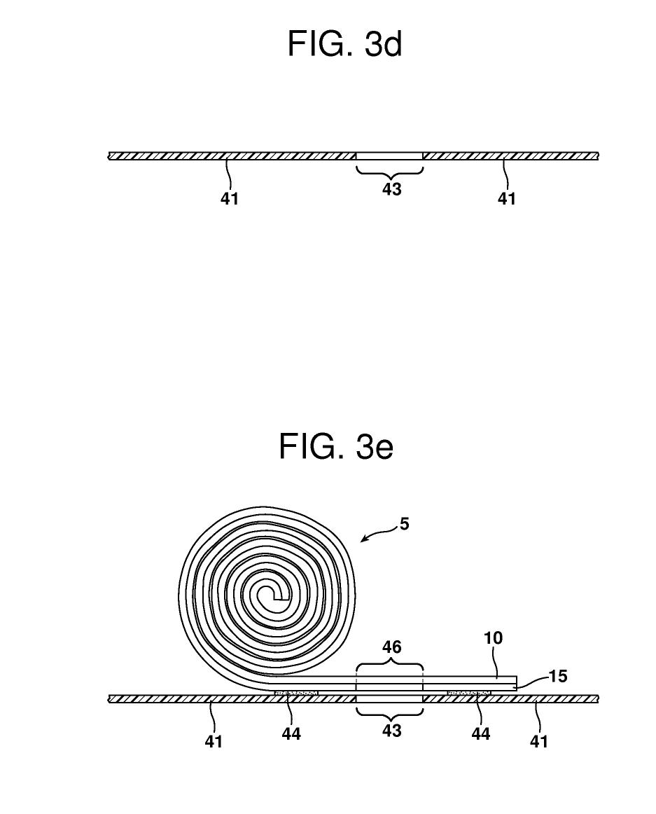

As set forth above, valve 5 can be used with a package for a wide variety of applications. To this end, FIGS. 3a and 3b illustrate one embodiment of a package in accordance with the presently disclosed subject matter. Particularly, package 40 comprises internal storage area 45 formed by bonding two flexible plastic sheets 41, 42 at seals 55a, 55b, 55c, and 55d along edges 50a, 50b, 50c, and 50d, respectively. Although the package of FIG. 3a is depicted as rectangular in shape, the presently disclosed subject matter includes packages formed in any shape.

In some embodiments, vent 5 can be incorporated between sheets 41, 42 along one edge of package 40 using any suitable means, including (but not limited to) heat seal, adhesives, and the like. In the embodiment illustrated in FIGS. 3a and 3b, package films 41, 42 can be joined together through an edge seals 55a-d. The edge seals also join package top film ply 41 and valve upper film 10. In addition, the edge seals join package bottom film ply 42 and lower film 15. The seals as applied thus secure valve 5 hermetically within package 40 and allow the valve to fluidly communicate with the interior of the package. To this end, input opening 30 of valve 5 is positioned within storage area 45 of package 40 and exhaust opening 35 is positioned outside package 40, as illustrated in FIG. 3c.

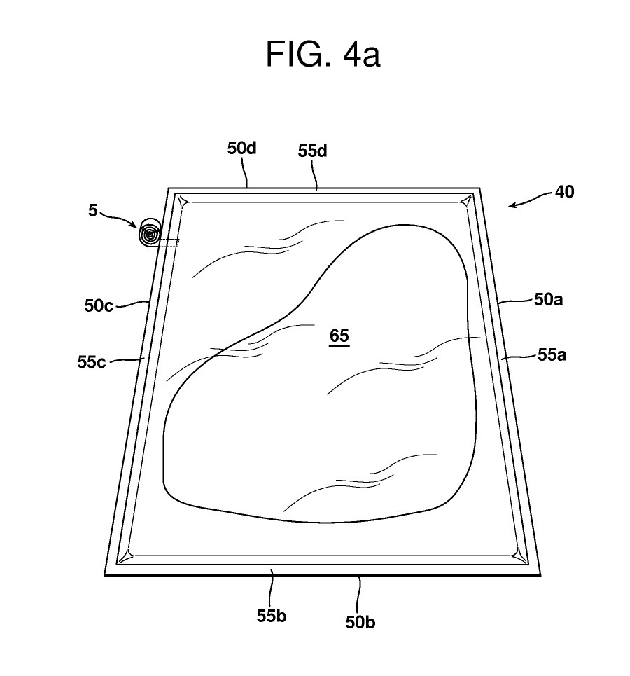

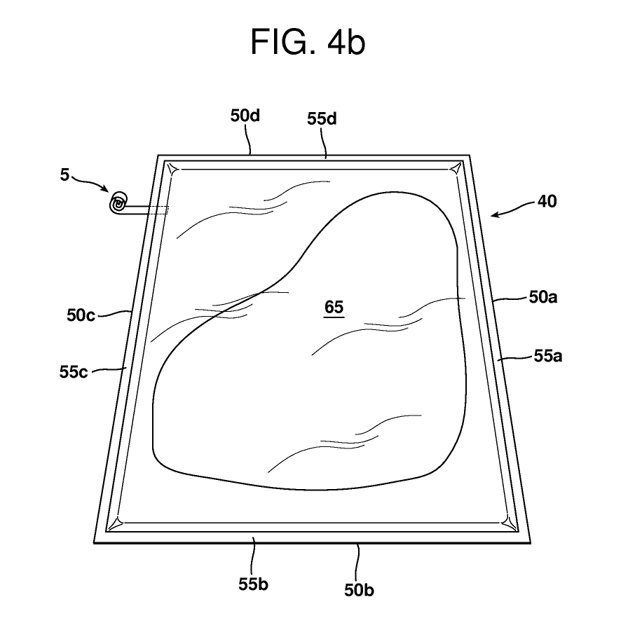

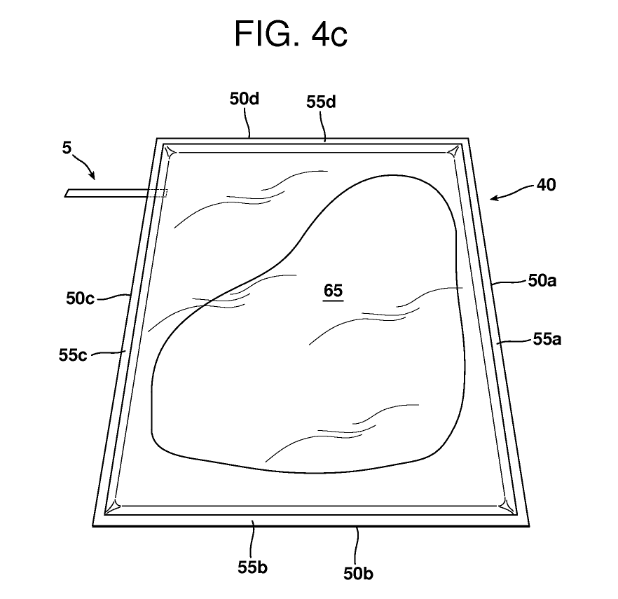

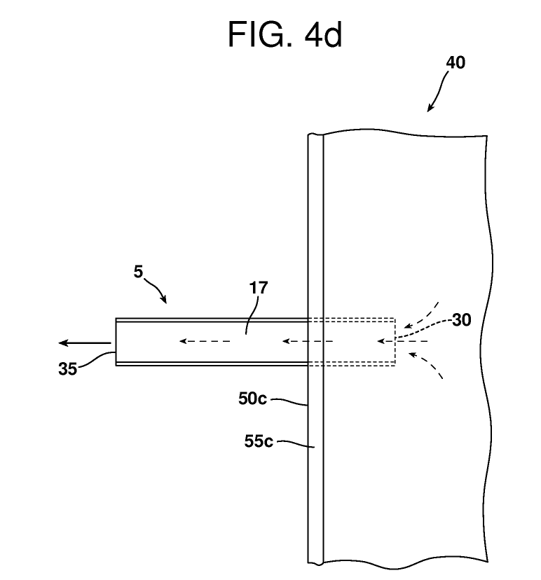

Alternatively, in some embodiments, vent 5 can be adhered or sealed over an opening (such as a vent hole) in package 40. Particularly, as illustrated in FIG. 3d, in some embodiments package 40 comprises one or more openings 43 that span one of package films 41, 42. As shown in FIG. 3e, valve 5 can be attached to package 40 to cover opening 43 via attachment means 44. Any of a wide variety of adhesives and heat seals known in the art can be employed as attachment means 44. In these embodiments, lower valve film 15 also comprises an opening to allow access to channel 17. Thus, when used in venting applications (but not limited to such applications), air travels through package opening 43, into vent opening 46 and through channel 17 to uncurl the valve and exit at exhaust opening 35, as set forth herein (see FIG. 4d). After the package has finished venting, valve 5 recoils and thus reseals the package. When it is desired to open package 40, in some embodiments, valve 5 can be pulled off, initiating a package tear. One of ordinary skill in the art would recognize that the presently disclosed subject matter is not limited to embodiments wherein valve 5 is used as an opening means. Rather, any of a wide variety of opening means known in the art can be used.

In some embodiments, package 40 is used to heat and/or cook a food product in an oven or microwave, as illustrated in FIGS. 4a-4c. In such embodiments, package 40 is constructed from food safe materials (such as nylon, polyolefin, and/or PET, for example), as would be known to those of ordinary skill in the art. In use, the package of FIG. 4a is placed in an oven or microwave. As heating/cooking proceeds, steam is generated within storage area 45. As illustrated in FIG. 4b, when the amount of steam created within package 40 reaches a level at which it begins to impinge on the integrity of the coiled valve, valve 5 begins to unroll and steam will begin to move through the valve as the pressure inside increases. Particularly, as the pressure continues to increase, valve 5 continues to unroll and steam passes from input opening 30 of valve 5, along channel 17 and exits the valve through exhaust opening 35 to vent the package, as illustrated in FIG. 4c. FIG. 4d illustrates the position of the valve of FIG. 4c and the arrows indicate the direction of steam movement. After the package has finished cooking and the pressure within the interior of the package decreases to ambient levels, the holding force on vent 5 is reduced such that the walls re-curl to maintain the vent in the closed position illustrated in FIG. 4a. Particularly, valve 5 rolls up, pressing sheets 10, 15 against one another and thereby closing exhaust opening 35 and creating a relatively air tight seal.

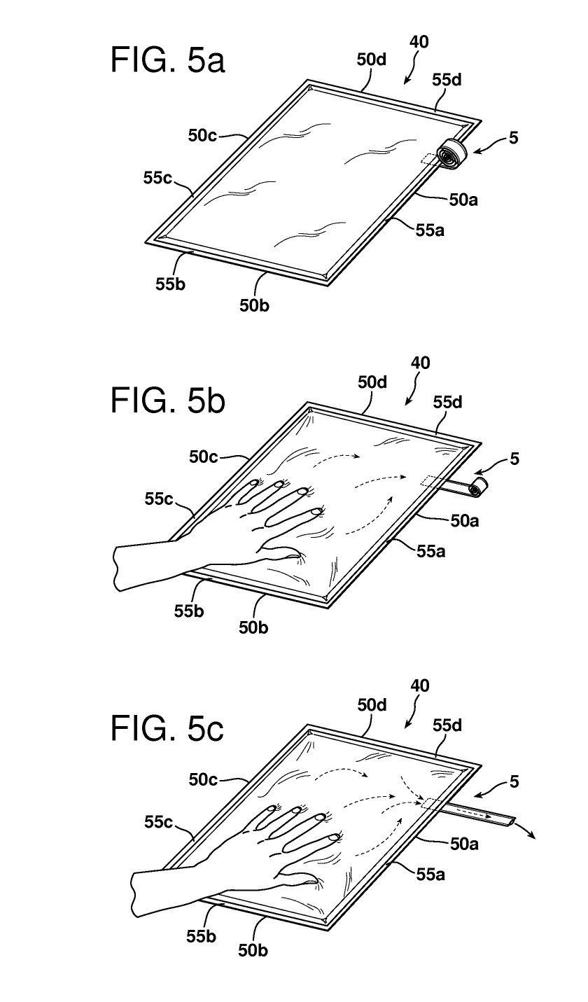

In some embodiments, package 40 can be a compression-type package and valve 5 can be incorporated therein as a means to manually express air from the interior of the package, as illustrated in FIGS. 5a-5c. Particularly, in these embodiments, package 40 can be a squeezable container comprising at least one flexible wall that can be grasped by the user and squeezed or compressed to increase the internal pressure within the package. During normal (at rest) conditions, valve 5 retains a coiled position, as shown in FIG. 5a. However, the squeezing of the package will compress the air housed within the interior of the package and raise the internal pressure therein. As the pressure increases, the curling forces of valve films 10 and/or 15 that hold valve 5 in a coiled position are overcome, and the valve uncoils to allow the package to vent, as illustrated in FIGS. 5b and 5c. Particularly, air travels from within the interior of the package and enters valve 5 at input opening 30, travels down channel 17, and exits the valve at exhaust opening 35. When squeezing forces are removed or the pressure within the interior of package 40 is at about ambient levels, the valve returns to the coiled configuration depicted in FIG. 5a.

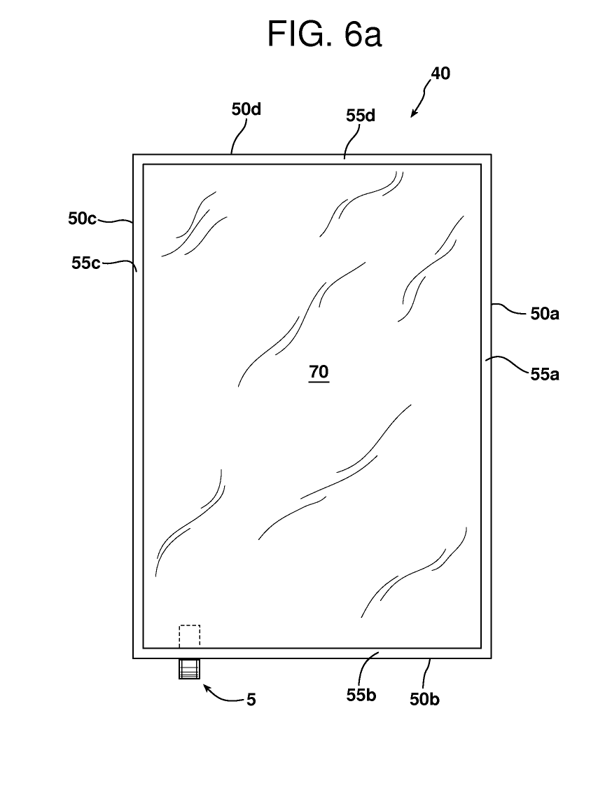

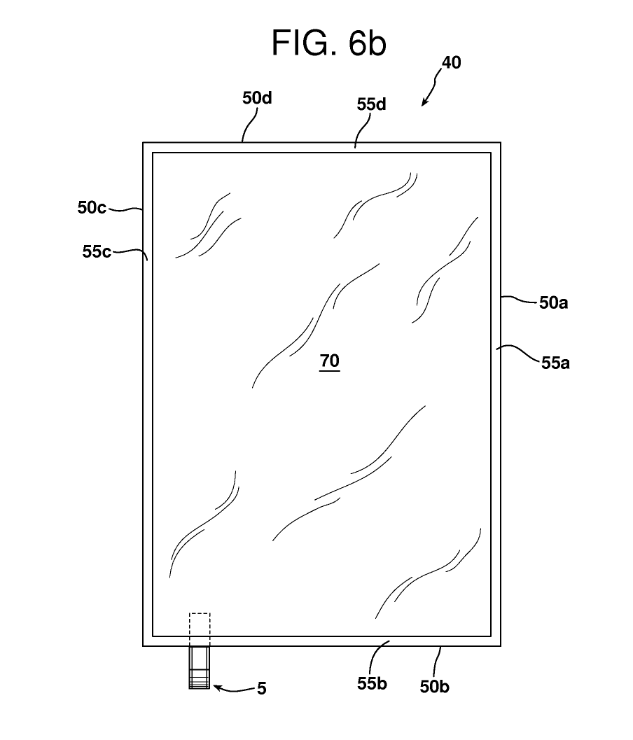

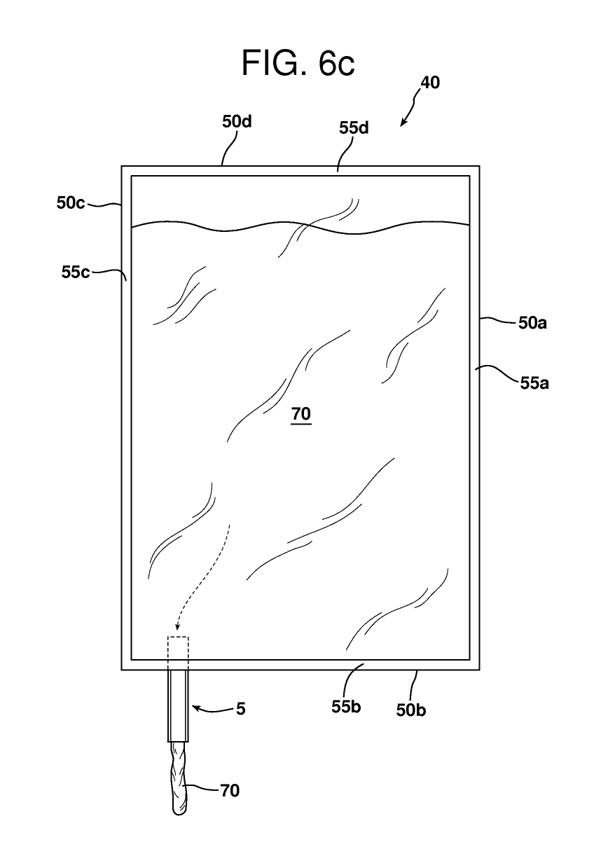

In some embodiments, package 40 can house a flowable product and valve 5 can be used to dispense the flowable product from the interior of the package, as illustrated in FIGS. 6a-6c. To this end, FIG. 6a illustrates one embodiment of package 40 housing flowable product 70. In these embodiments, package 40 can be a squeezable container having at least one flexible wall that can be grasped by the user and squeezed or compressed. The squeezing of the package will compress the flowable product housed within the interior of the package to raise the internal package pressure. As the pressure increases, the coiling forces that hold valve 5 in a coiled position are overcome, and the valve uncoils to allow the flowable product to travel through vent 5 and exit the package, as shown in FIGS. 6b and 6c. Particularly, flowable product travels from within the interior of the package and enters valve 5 at input opening 30, travels down channel 17, and exits the valve at exhaust opening 35. When squeezing forces are removed or the pressure within the interior of package 40 is at about ambient levels, the valve returns to its normal, coiled configuration.

In some embodiments, valve 5 can be used as a vent valve to vacuumize a package. In these embodiments, a product can be packaged using a flow wrap-type machine, where seals are created on each side around the product. In some embodiments, valve 5 can be applied on the flow wrap machine. The package can then be vacuumized in a chamber machine that has no seal bars. Valve 5 allows all of the air to escape the package, and then self-closes by coiling as set forth herein above. Accordingly, the vacuumizing machine needs no seal bars, and thus is significantly less expensive compared to similar machinery that requires seal bar machinery. In addition, the vacuumizing machine operates about 30-50% faster because no time is needed for creating package seals. In some embodiments, shrinking provides a final lockdown seal on the valve. Alternatively or in addition, the seal can be locked by using pressure-activated or UV-activated adhesives.

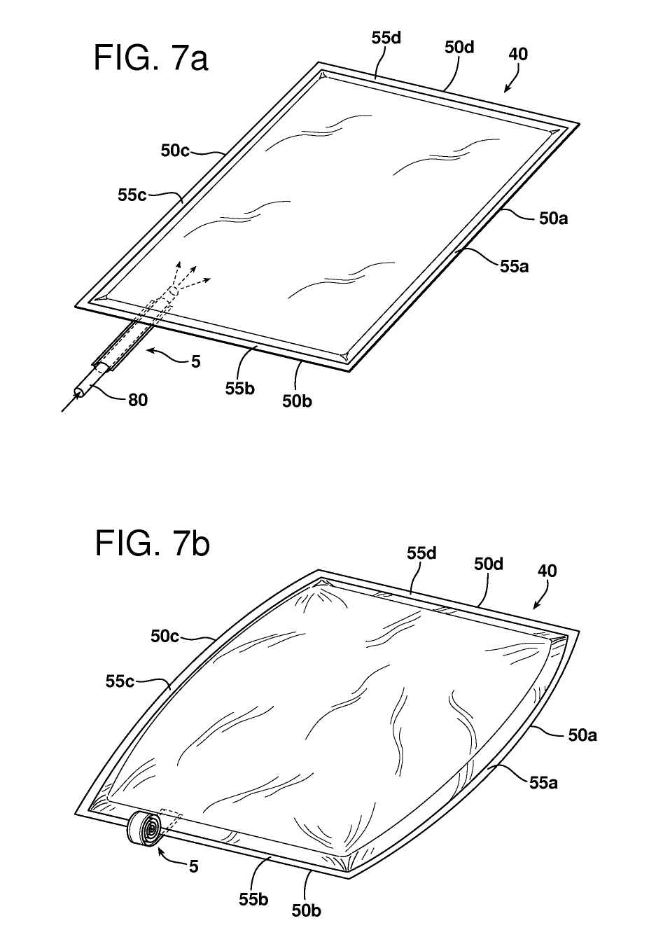

In some embodiments, package 40 can be an inflatable article (such as a mailer or dunnage item) comprising valve 5, as illustrated in FIGS. 7a and 7b. In these embodiments, valve 5 is used to introduce a controlled volume of gas into the inflatable article. For example, valve 5 can be manually unrolled to open the valve. Thus, valve 5 can be adapted to receive an injection device when the valve is in the open position, as illustrated in FIG. 7a. The injection device can be any conventional device used to direct flowing air or fluid in a desired manner, e.g., a nozzle or the like. For example, in some embodiments, the inflation nozzle can be part of an inflation apparatus disclosed in U.S. Pat. Nos. 6,253,806; 6,253,919; 6,561,236; or 6,729,110, all of which are hereby incorporated by reference in their entireties. As would be apparent to those of ordinary skill in the art, inflation device 80 can be connected to an air source. Air can thus flow from the injection device into valve 5 via exhaust opening 35, through channel 17, and into the internal portion of the inflatable article through input opening 30. The inflatable article can be inflated with gas (such as air or lighter-than-air gas) and liquids (such as liquid water or one or more liquid precursors that may subsequently react, for example, to form a foam). After the inflatable article has been filled to a desired amount, the inflation device can be removed and valve 5 is allowed to recoil, as illustrated in FIG. 7b.

In applications where a hermetic seal is required, at least a portion of valve 5 can be coated with a component that bridges small gaps. For example, in some embodiments, silicone fluid and similar viscous materials can be used to coat the interior of valve 5 (i.e., channel 17). Alternatively or in addition, in some embodiments, packages comprising the disclosed valve can employ magnet components on one portion of the package to allow the package sides to come into intimate contact. Particularly, the packages can comprise a plurality of magnets that are operatively arranged to attract each other when placed in close proximity. The magnetic attraction between the magnets retains the package sides in contact. One of ordinary skill in the art would recognize that these features are merely optional and the presently disclosed subject matter includes valves and packages without such features.

### V. Benefits of the Disclosed Valve

As set forth herein above, valve 5 comprises many benefits that would prove useful in the packaging art. For example, one benefit of valve 5 is that the valve is self-opening and self-closing. Specifically, the valve is capable of opening and closing in response to an increase in pressure (or other means) without assistance from a user. Thus, the disclosed valve is easy to operate and does not require user input.

In addition, valve 5 is capable of maintaining itself in an opened configuration to allow fluid or air to flow out of the package without the need for external manipulation or support.

Continuing, the coiled configuration and sealing capabilities of valve 5 guarantee clean handling of package 40 and the materials housed within the package.

Further, because the valve 5 is self-sealing, it can be used to protect the contents of a package for long periods of time. As a result, the storage life of products housed within the disclosed packages can be extended, even after a package has been opened.

Continuing, the disclosed valve is relatively inexpensive to manufacture, compared to prior art valves known and used in the art.

In addition, the process for producing valve 5 can be carried out on conventional packaging machinery already commonly used in the packaging art.

Moreover, the disclosed valve can be entirely constructed of thermoplastic films such that the valve is substantially completely flat when not in use, i.e., when no fluid flows through the valve. Further, valve 5 can be made entirely from a single type of material, e.g., a heat-sealable, thermoplastic film or any of a number of other possibilities, which simplifies the manufacture of such valves.

Additionally, valve 5 has a wide array of end-use applications in fields ranging from cook-in packaging to inflatable articles.

As set forth herein above, the use of the coiled concept allows the use of a thinner valve film, which can lead to reduced manufacturing costs.

One of ordinary skill in the art would recognize that the disclosed valve has many benefits, and is not limited to the benefits set forth herein.

### EXAMPLES

The following Examples provide illustrative embodiments of the presently disclosed subject matter. In light of the present disclosure and the general level of skill in the art, those of ordinary skill will appreciate that the following Examples are intended to be exemplary only and that numerous changes, modification, and alterations can be employed without departing from the scope of the disclosed subject matter.

### Example 1

### Manufacture and Vacuumization of Packages

2 valves were constructed using Cryovac® LID1051 lidstock (available from Sealed Air Corporation, Duncan, S.C., United States of America) containing natural curl. Specifically, the natural curl was created by tensioning one sheet of the laminated film 1.5 to 4 times more than the other sheet of the laminated film.

Valves about 3 inches long and about 1 inch wide were created using an impulse heat seal to create the seals along the side of two layers of the LID1051 film. The layers of the film were oriented so that the curl on each layer complimented the curl on the other layer. An impulse seal was created using a desktop impulse sealer so that the seals would not have any shrink (Impulse Sealer Model No. A1E-405HIM, available from American International Electric, Inc., Whittier, Calif., United States of America). The impulse sealer was controlled with 2 timers (one controlled how long the wire was energized and one controlled the amount of cooling time). To make the coiled valves, the seal timer was set at about 5 and the cooling timer was set at about 8.

Each valve was then applied to a standard Cryovac® shrink barrier bag (Bags B2170, B2370, B2630, B4170, B4370, B4680, and B4770, available from Sealed Air Corporation, Duncan, S.C., United States of America) by thermally sealing to the inside edge of the bag using the impulse sealer and conditions stated above, with one end of the valve communicating with the inside of the bag, and the other end of the valve communicating with the outside atmosphere.

During sealing, a portion of Teflon tape was used to keep the inner layers of the valve from becoming sealed to each other. Particularly, a portion of Teflon coated fiberglass fabric was cut to the match the inside width of the valve. The Teflon fabric was then placed between the inner layers of the valve to prevent the valve from sealing. The valve with the Teflon tape was next placed between the seal layers of the open bag and a seal was made across the bag and the valve, sealing the bag to the outside of the valve and to itself where the valve was not located. The Teflon tape prevented the inner layers of the valve from sealing during this step. Additional samples were made by thermally sealing the valve such that it surrounded a hole that was made in the wall of the bag.

Product was then placed in each bag and the bag was sealed using the impulse lab sealer and conditions set forth above. The product in one bag was a small stack of paper towels. The product in the second bag was a small block of foam. Each package was then placed in the chamber of a Multivac® vacuum packaging machine (Ultravac model UV2100, available from Koch Equipment, Kansas City, Mo., United States of America) and vacuumized by reducing the pressure inside the chamber to an absolute pressure of about 5 to 10 Torr.

It was observed that during vacuumizing, the packages ballooned up and the vent uncurled on each package and allowed the air inside the bags to be exhausted. When the chamber was vented, each bag curled up and the products contained within the packages collapsed due to external air pressure. When the pressure within the chamber returned to atmospheric pressure, the vents re-curled and resealed. It was observed that both packages held vacuum for over 1 hour. It was also observed that the valves did not appear to be objectionable to the package appearance, as they curled up closely to the product surface.

### Example 2

### Comparative Testing

Several barrier bags containing vent valves were prepared as in Example 1. In addition, several barrier bags containing vent valves formed from Cryovac® LID1051 flat film (without the curl tendency) to provide a direct comparison as to the effect of the natural curl tendency on films that had similar structures, thicknesses, and stiffness. The valves on the bags were then tested as in Example 1, where they were inserted into a vacuum chamber and the pressure in the chamber was then reduced.

It was observed that valves constructed from the “flat” (non-curled) film did not reseal. In addition, within a few minutes after removal from the vacuum chamber, the packages leaked and allowed outside air to enter the package and loosen the film from the surface of the product.

It was observed that packages containing the “flat” tubing valve required about twice the length of a curled valve to get good sealing. However, these valves were objectionable to the product appearance, as they extended about 6 inches outside the package.

What is claimed is:

1. A flexible valve comprising: a first sheet of thermoplastic material and a second sheet of thermoplastic material in juxtaposed face-to-face relationship with each other, wherein said first and second sheets are sealed together along the longitudinal edges of said sheets, defining a channel there between and defining an inlet end and an outlet end; and wherein at least one of said first and second sheets comprises a curl tendency in one direction;
wherein said valve is movable between:
a. an open, uncoiled position to allow fluid flow through said valve;
b. a closed, coiled position to substantially prevent fluid flow through said valve;
wherein said valve is capable of maintaining itself in a closed position at rest and an open position when in use without the need for external manipulation of the valve.

2. The valve of claim 1, wherein said first and second sheets are sealed together with a heat seal, adhesive seal, or e-beam curable adhesive seal.

3. The valve of claim 1, wherein said first sheet and said second sheet comprise at least one barrier layer.

4. The valve of claim 1, wherein said curl tendency is achieved by slightly stretching at least one layer of at least one of first and second sheets during lamination.

5. The valve of claim 1, wherein at least one of said first and second sheets comprise at least one layer that shrinks or expands when exposed to water, humidity, heat, or combinations thereof.

6. The valve of claim 1, wherein said curl tendency is created by heat setting at least one of said first and second sheets.

7. The valve of claim 1, wherein said curl tendency is created by monoaxially orienting a multilayer film in the machine direction or the transverse direction.

8. The valve of claim 1, wherein said curl tendency is created by coextruding an asymmetric multilayer film.

9. The valve of claim 1, wherein said fluid is selected from the group comprising: liquids, gelatinous substances, air, or combinations thereof.

10. A package comprising a flexible valve comprising: a first sheet of thermoplastic material and a second sheet of thermoplastic material in juxtaposed face-to-face relationship with each other, wherein said first and second sheets are sealed together along the longitudinal edges of said sheets, defining a channel there between and defining an inlet end and an outlet end; and wherein at least one of said first and second sheets comprises a curl tendency;
wherein said valve is movable between:
a. an open, uncoiled position to allow fluid flow through said valve;
b. a closed, coiled position to substantially prevent fluid flow through said valve;
wherein said valve is capable of maintaining itself in a closed position at rest and an open position when in use without the need for external manipulation of the valve.

11. The package of claim 10, wherein said valve is positioned along one edge of said package.

12. The package of claim 10, wherein said valve is positioned over an opening in said package.

13. The package of claim 10, wherein said package is used to heat or cook a food product.

14. The package of claim 10, wherein said package is used to vacuumize a product.

15. The package of claim 10, wherein said package is used to express air from the interior of said package.

16. The package of claim 10, wherein said package is used to dispense a product housed within said package.

17. A method of venting a package, said method comprising:
a. providing a package comprising:
i. a product housed within the interior of said package;
ii. a flexible valve comprising: a first sheet of thermoplastic material and a second sheet of thermoplastic material in juxtaposed face-to-face relationship with each other, wherein said first and second sheets are sealed together along the longitudinal edges of said sheets, defining a channel there between and defining an inlet end and an outlet end; and wherein at least one of said first and second sheets comprises a curl tendency;
b. increasing the pressure within the interior of said package to cause said valve to open and uncoil to vent said package;
wherein said valve is movable between an open, uncoiled position to allow air flow through said valve and a closed, coiled position to substantially prevent air flow through said valve;
wherein said valve is capable of maintaining itself in a closed position at rest and an open position when in use without the need for external manipulation of the valve.

18. A method of dispensing a product from the interior of a package, said method comprising:
a. providing a package comprising:
i. a product housed within the interior of said package;
ii. a flexible valve comprising: a first sheet of thermoplastic material and a second sheet of thermoplastic material in juxtaposed face-to-face relationship with each other, wherein said first and second sheets are sealed together along the longitudinal edges of said sheets, defining a channel there between and defining an inlet end and an outlet end; and wherein at least one of said first and second sheets comprises a curl tendency;
b. increasing the pressure within the interior of said package to allow said valve to open and uncoil to dispense said product;
wherein said valve is movable between an open, uncoiled position to allow product flow through said valve and a closed, coiled position to substantially prevent product flow through said valve;
wherein said valve is capable of maintaining itself in a closed position at rest and an open position when in use without the need for external manipulation of the valve.

19. A method of inflating an inflatable package, said method comprising:
a. providing an inflatable package comprising a flexible valve comprising a first sheet of thermoplastic material and a second sheet of thermoplastic material in juxtaposed face-to-face relationship with each other, wherein said first and second sheets are sealed together along the longitudinal edges of said sheets, defining a channel there between and defining an inlet end and an outlet end; and wherein at least one of said first and second sheets comprises a curl tendency;
b. uncoiling said valve;
c. inserting an inflation device into said channel of said valve;
d. inserting air into the interior of said package via said inflation device;
e. withdrawing said inflation device from said valve channel;
f. allowing said valve to recoil;
wherein said valve is movable between an open, uncoiled position to allow air flow through said valve and a closed, coiled position to substantially prevent air flow through said valve;
wherein said valve is capable of maintaining itself in a closed position at rest without the need for external manipulation of the valve.

20. A method of venting a package, said method comprising:
a. providing a package comprising:
i. a product housed within the interior of said package;
ii. a flexible valve comprising: a first sheet of thermoplastic material and a second sheet of thermoplastic material in juxtaposed face-to-face relationship with each other, wherein said first and second sheets are sealed together along the longitudinal edges of said sheets, defining a channel there between and defining an inlet end and an outlet end; and wherein at least one of said first and second sheets comprises a curl tendency;
b. creating a differential pressure across the inner and outer portions of the package to cause said valve to open and uncoil to vent said package;
wherein said valve is movable between an open, uncoiled position to allow air flow through said valve and a closed, coiled position to substantially prevent air flow through said valve;
wherein said valve is capable of maintaining itself in a closed position at rest and an open position when in use without the need for external manipulation of the valve.
